(19) United States
(12) Patent Application Publication
(10) Pub. No.: US 2010/0187871 A1
(43) Pub. Date: Jul. 29, 2010

(54) Elliptical frame bicycle seat

(76) Inventor: Vincent Dean Herreid, Holt, MI (US)

Correspondence Address: Vincent Dean Herreid, 1642 Grayfriars Ave., Holt, MI, 48842, US

(21) Appl. No.: 12/321,585

(22) Filed: Jan. 23, 2009

(51) Int. Cl. B62J 1/18

(52) U.S. Cl. 297/214

(57) ABSTRACT

A light, strong, flattened in appearance elliptical frame 10 bicycle seat. Lips 12 encircle and enclose the seat at both sides to hold encircling pads in place, to help prevent sidewards displacement of the rider, and to give added strength to the whole. The seat depends on current, common seat post mounting for adjustments and to hold it in place. Obvious reinforcement needed is represented by large diameter washers 16 where the seat post mounting bolt enters the lower side of the frame 10.

### CROSS REFERENCE TO RELATED APPLICATIONS

Not applicable.

### BACKGROUND

1. Field of the Invention

Many bicycle seat designs have been proposed and patented in more than the last 100 years.

2. Description of Prior Art

Previous designs have Permanently matched parts of the anatomy to cushioned and springing supports. My invention is designed to greatly increase comfort and efficiency of the user.

### SUMMARY

A flattened elliptical seat frame with a lip around each side to help prevent sidewards motion of the rider off of his perch. Any light, stiff, strong material with a cushioning “give” will suffice.

Twin encircling pads are designed to remain in Position in use but rotatable to expose less compressed by use Pad areas, to serve as a seating area.

### OBJECTS AND ADVANTAGES

The smooth seating area allows for back and forth movement of the rider as well as a small amount of twisting of the torso. The average rider will move slightly forwards for a freer maximum use of the upper leg pedaling muscles. With less exertion or when coasting, the rider moves slightly backwards for a continuous relief from weight bearing on mostly the same portion of the anatomy.

### DRAWING FIGURES

FIG. 1 is a top view of the seat

FIG. 2 is a view from either side.

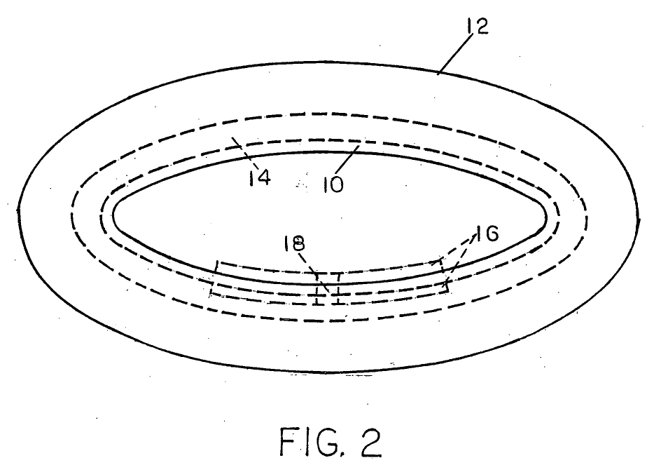

FIG. 3 is a front or back view.

### REFERENCE NUMERALS IN DRAWINGS

| | | | |
|---|---|---|---|
| 10 | frame | 12 | lip of frame |
| 14 | circular pad | 16 | reinforcing washer |
| 18 | slot for mounting bolt | | |

### DESCRIPTION—PREFERRED EMBODIMENT

Sheet aluminum is a typical material for the frame 10. Many other metal or non metal materials are possible. The frame 10 material is to be light, strong and almost rigid, with a slight springing give to it for maximum comfort of the rider.

The circular pads 14 fit best elastically and snugly in position during use, but are rotatable to present a less compressed portion to the weight of the rider.

The elliptical crossection of the seat frame 10 gives it great strength for a relatively thin material. The addition of elliptically shaped lips 12 at the sides gives additional strength to resist deformation in any direction.

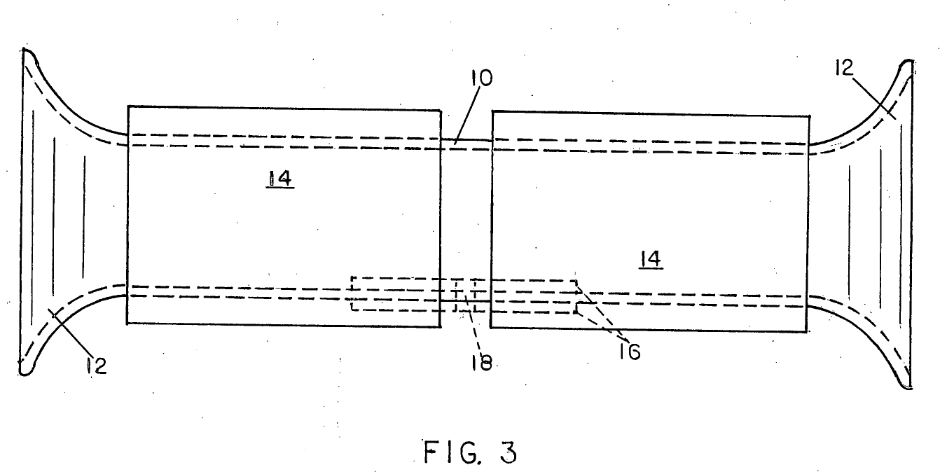

In FIG. 3 the fore and aft curvature of the large diameter reinforcing washers 16 is not attempted to be shown to preserve clarity.

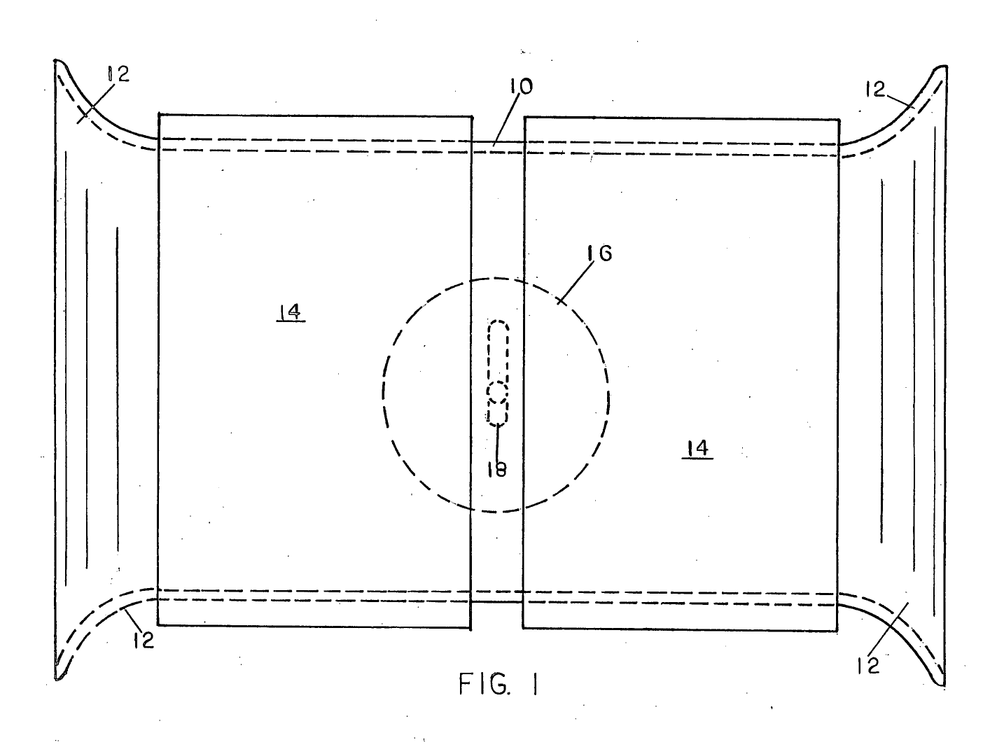

### Operation—FIGS. 1,2, and 3

The function of the seat is obvious and straightforward, there being no moving parts during use except for the springing and cushioning actions of the frame 10 and the pads 14.

The frame 10 is secured in place with a bolt through the seat post assembly (not shown). The slot 18 in the lower part of the frame 10, FIG. 1, allows for a fore and aft adjustment of the seat.

A standard for and aft tilting adjustment is expected to be incorporated in the seat post assembly (not shown).

The flexible pads 14 can be rotated periodically to bring lesser compressed portions to the top.

The lips 12 on each side of the frame 10 hold the pads 14 in place and also help prevent overly sidewards displacement of the rider.

It is apparent that a telescoping arrangement could be added to the tubular nature of the the construction for a width adjustment. This is considered to be an obvious modification and covered by this patent application.

### CONCLUSION, RAMIFICATIONS, AND SCOPE

Current acceptable bicycle seats mate small portions of the anatomy continuously to small matching portions of cushioned and springing support. Larger current cushioned seats tend to inhibit pedaling muscles of the upper leg. Fatigue, chafing and soreness is the result of concentration of a riders weight on small bearing surfaces.

My invention features a relatively large, smooth seating area without the addition of undue weight.

Simplicity of design and manufacture combine for the optimun bicycle seat.

I claim:

1. A new, comfortable, flattened elliptical design bicycle seat with inherent shock absorbing qualities combined with the obvious mountings and adjustments of current bicycle technology.

2. A cushioning circular pad, probably best in two split parts, to remain fixed in place during use but rotatable to bring the uncompressed portion from underneath to the top for maximum continuous rider comfort and efficiency.

3. The concave to the inner side and convex to the outer side elliptical lips on either side of the seat frame. Not claimed as barriers to sideward slippage of the rider, but as reinforcing, stiffening rings adding strength to the seat frame and helping to prevent deformation of the seat frame in all directions.
